(19) United States
(12) Patent Application Publication
(10) Pub. No.: US 2011/0286605 A1
(43) Pub. Date: Nov. 24, 2011

(54) NOISE SUPPRESSOR

(75) Inventors: Satoru Furuta, Tokyo (JP); Hirohisa Tasaki, Tokyo (JP)

(73) Assignee: MITSUBISHI ELECTRIC CORPORATION, TOKYO (JP)

(21) Appl. No.: 13/146,938

(22) PCT Filed: Apr. 2, 2009
(86) PCT No.: PCT/JP09/01554

§ 371 Date: Jul. 29, 2011

(51) Int. Cl. G10K 11/16

(52) U.S. Cl. 381/71.1

(57) ABSTRACT

A voice/noise section decision unit 2 makes a decision from a low-frequency amplitude spectrum 102 as to whether an input signal 100 is like a voice or not. A noise spectrum estimation unit 3 estimates a low-frequency noise spectrum and high-frequency noise spectrum from the output of the voice/noise section decision unit 2. A low-frequency processing unit 201 and a high-frequency processing unit 202 perform noise suppression based on the noise spectrum output from the noise spectrum estimation unit 3.

### TECHNICAL FIELD

The present invention relates to a noise suppressor for improving sound quality of a car navigation, mobile phone, voice communication system such as an intercom, hands-free telephone system, videoconferencing system, monitoring system and the like and for increasing the recognition rate of a voice recognition system by suppressing noise other than an object signal such as a voice/acoustic signal in a voice communication system, voice storage system, and voice recognition system in various noise environments.

### BACKGROUND ART

As a typical method of noise suppression for emphasizing a voice signal which is an object signal by suppressing noise which is an unintended signal from an input signal into which noise is mixed, there is, for example, a spectral subtraction (SS) method. It carries out noise suppression by subtracting an average noise spectrum estimated separately from an amplitude spectrum (see Non-Patent Document 1, for example).

As a conventional method of carrying out noise suppression separately for individual bands after converting the input signal into a frequency domain signal and then dividing it into prescribed narrow bands, there is one described in Patent Document 1, for example. In addition, as a conventional method of switching between systems with different sampling frequencies (switching between a narrow-band noise suppression system and a wide-band noise suppression system), there is one described in Patent Document 2, for example.

The method described in Patent Document 1, which is based on the method disclosed in Non-Patent Document 1, aims to achieve a noise suppressor capable of reducing voice distortion with a small amount of processing and increasing a noise suppression amount by dividing an input signal to a low-frequency component and a high-frequency component and by carrying out noise suppression suitable for each band.

In addition, the method described in Patent Document 2 aims to improve the quality of decoded voice by comprising noise suppression processing corresponding to a plurality of sampling conversion rates and a switching unit and by switching the sampling frequency and noise suppressor suitable for voice decoding processing.
Patent Document 1: Japanese Patent Laid-Open No. 2006-201622 (pp. 4-9 and FIG. 1)
Patent Document 2: Japanese Patent Laid-Open No. 2000-206995 (pp. 6-16 and FIG. 4)
Non-Patent Document 1: Steven F. Boll, “Suppression of Acoustic Noise in Speech Using Spectral Subtraction”, IEEE Trans. ASSP, Vol. ASSP-27, No. 2, April 1979.

The foregoing conventional methods, however, have the following problems.

For example, the conventional noise suppressor disclosed in Patent Document 1, which has independent configurations for a low-frequency range and high-frequency range, necessitates separate voice/noise section decision units for the low-frequency range and high-frequency range. Accordingly, it still has a problem of having a large amount of processing and memory volume although less than those of all-band processing. As for control parameters for the voice/noise section decision and noise spectrum estimation, which are important in the noise suppressor, they must be adjusted independently for the low-frequency range and high-frequency range, thereby offering a problem of complicating the control and adjustment.

As for the conventional noise suppressor relating to the receiving apparatus disclosed in the Patent Document 2, it has noise suppression processing for each of the plurality of sampling frequency ranges. Accordingly, as in the case of the Patent Document 1, it has a problem of being it necessary to adjust the control parameters independently, and to possess a program memory for each noise suppression processing, thereby increasing the memory volume.

The present invention is implemented to solve the foregoing problems. Therefore it is an object of the present invention to provide a noise suppressor capable of achieving noise suppression with a lower amount of processing and memory volume and with lesser quality deterioration, and to provide a noise suppressor capable of facilitating its control and adjustment.

### DISCLOSURE OF THE INVENTION

A noise suppressor in accordance with the present invention is configured in such a manner as to divide an input signal into a plurality of bands, and to make noise suppression of prescribed band components and noise suppression of band components other than the prescribed bands in accordance with an analysis result of the prescribed band components among the plurality of bands passing through the division. This makes it possible to provide a noise suppressor capable of reducing the amount of processing and memory volume and facilitating its control and adjustment.

### BRIEF DESCRIPTION OF THE DRAWINGS

FIG. 1 is a block diagram showing a whole configuration of an embodiment 1 of a noise suppressor in accordance with the present invention;

FIG. 2 is a block diagram showing an internal configuration of a noise spectrum estimation unit described in the embodiment 1 in accordance with the present invention;

FIG. 3 is a diagram showing an example of subbanding a noise spectrum described in the embodiment 1 in accordance with the present invention;

FIG. 4 is a block diagram showing a whole configuration of an embodiment 2 of the noise suppressor in accordance with the present invention; and

FIG. 5 is a block diagram showing a whole configuration of an embodiment 4 of the noise suppressor in accordance with the present invention.

### BEST MODE FOR CARRYING OUT THE INVENTION

The best mode for carrying out the invention will now be described with reference to the accompanying drawings to explain the present invention in more detail.

### Embodiment 1

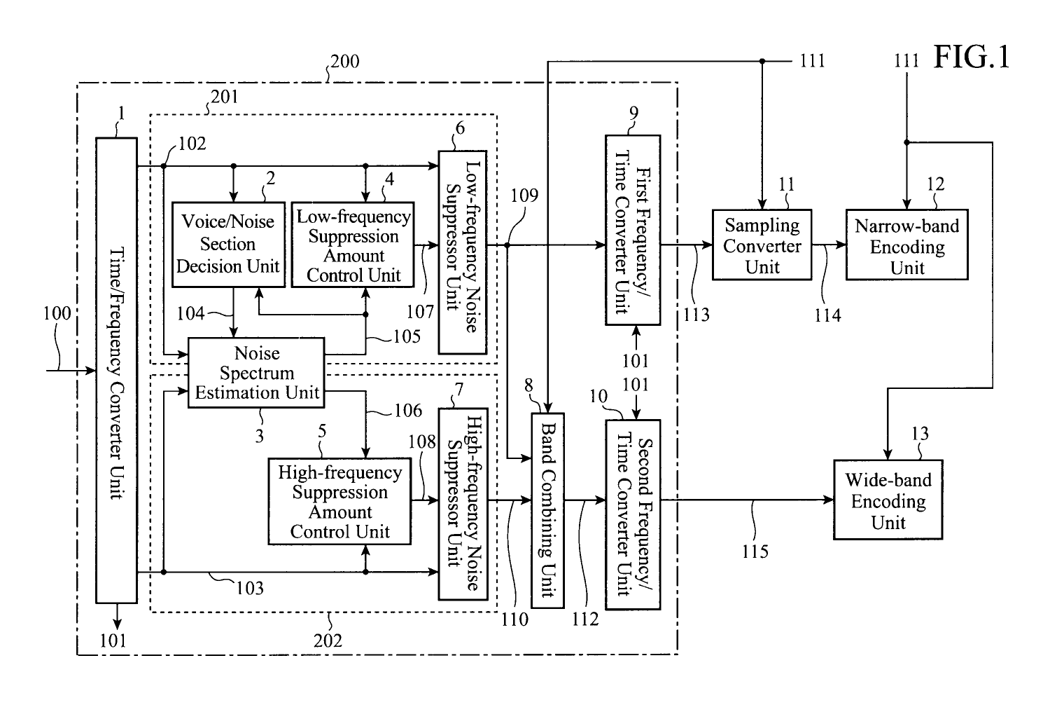

FIG. 1 is a block diagram showing a whole configuration of the noise suppressor in accordance with the present invention.

In FIG. 1, a noise suppressor 200 comprises a time/frequency converter unit 1, a voice/noise section decision unit 2, a noise spectrum estimation unit 3, a low-frequency suppression amount control unit 4, a high-frequency suppression amount control unit 5, a low-frequency noise suppressor unit 6, a high-frequency noise suppressor unit 7, a band combining unit 8, a first frequency/time converter unit 9, and a second frequency/time converter unit 10. In addition, the voice/noise section decision unit 2, low-frequency suppression amount control unit 4 and low-frequency noise suppressor unit 6 constitute a low-frequency processing unit 201, and the high-frequency suppression amount control unit 5 and high-frequency noise suppressor unit 7 constitute a high-frequency processing unit 202. Besides, the noise spectrum estimation unit 3 is provided as a common component to the low-frequency processing unit 201 and high-frequency processing unit 202.

It differs from a conventional noise suppressor in that it has the voice/noise section decision unit 2 only in the low-frequency processing unit 201 and that the noise spectrum estimation unit 3 constitutes a common component to the low-frequency processing unit 201 and high-frequency processing unit 202.

The operation principle of the noise suppressor shown in FIG. 1 will be described below.

First, an input signal 100 consisting of an object signal such as voice and musical sounds and noise mixed therewith undergoes A/D (analog/digital) conversion, followed by being sampled at a prescribed sampling frequency (16 kHz, for example), divided into frames with a prescribed frame length (20 msec, for example), and supplied to the time/frequency converter unit 1 in the noise suppressor 200.

The time/frequency converter unit 1 performs a windowing operation (and zero filling operation as needed) on the input signal 100 divided into the frame length, and transforms the signal passing through the windowing from the signal on the time axis to a signal (spectrum) on the frequency axis using 512-point FFT (Fast Fourier Transform), for example. The amplitude spectrum S(n,k) and phase spectrum P(n,k) of the input signal 100 in the nth frame obtained from the time/frequency converter unit 1 can be given by the following expression (1).

$$\{ \begin{matrix}S ( n , k ) = \sqrt{Re {\{ X ( n , k ) \}}^{2} + Im {\{ X ( n , k ) \}}^{2}} \\ P ( n , k ) = X ( n , k ) ;\end{matrix} 0 \leq k < 512 / 2 \qquad ( 1 )$$

Here, k is a spectral number, Re{X(n,k)} and Im{X(n,k)} are the real part and the imaginary part of the spectrum of the input signal after FFT, respectively. Unless otherwise specified, the frame number is omitted as long as it represents the signal of the current frame.

As for the amplitude spectrum S(k) obtained above, it is divided into two bands of 0-4 kHz and 4-8 kHz, and the low-frequency component of 0-4 kHz is output as a low-frequency amplitude spectrum 102, and the high-frequency component of 4-8 kHz is output as a high-frequency amplitude spectrum 103, respectively, and a phase spectrum 101 is output.

The low-frequency amplitude spectrum 102 obtained is supplied to the voice/noise section decision unit 2, noise spectrum estimation unit 3, low-frequency suppression amount control unit 4, and low-frequency noise suppressor unit 6 in the low-frequency processing unit 201. In addition, the high-frequency amplitude spectrum 103 is supplied to the noise spectrum estimation unit 3, high-frequency suppression amount control unit 5, and high-frequency noise suppressor unit 7 in the high-frequency processing unit 202. As the windowing operation in the present embodiment, it can employ a well-known method such as Hanning window and trapezoidal window. In addition, since FFT is a well-known technique, the description thereof is omitted here.

First, the operation of the components in the low-frequency processing unit 201 will be described. Incidentally, as for the operation of the voice/noise section decision unit 2 for making a decision as to whether the mode of the input signal 100 is “like voice or not” and the operation of the noise spectrum estimation unit 3 which is a common component to the low-frequency processing unit 201 and high-frequency processing unit 202, they will be described later. First, according to the following expression (2), the low-frequency suppression amount control unit 4 calculates signal-to-noise ratio snr_{L} (k) for each spectral component from the low-frequency amplitude spectrum 102 and low-frequency noise spectrum 105 the noise spectrum estimation unit 3 outputs. Here, S_{L} (k) is a kth spectrum of the low-frequency amplitude spectrum 102, N_{L} (k) is a kth spectrum of the low-frequency noise spectrum 105, k is a spectral number, and K_{L} is the number of the spectral numbers. For example, if the number of FFT points is 512 and a band divide point is 4 kHz, then K_{L}=128. Using the signal-to-noise ratio snr_{L} (k) for each spectral component obtained, the low-frequency suppression amount control unit 4 calculates a low-frequency noise suppression amount 107. As a concrete calculation method, a well-known method can be used such as a spectral subtraction method disclosed in the Non-Patent Document 1, and the so-called Wiener Filter disclosed in J. S. Lim and A. V. Oppenheim, “Enhancement and Bandwidth Compression of Noisy Speech”, Proc. of the IEEE, vol. 67, pp. 1586-1604, December 1979 (referred to as Non-Patent Document 2 from now on).

$${snr}_{L} ( k ) = \{ \begin{matrix}\begin{matrix}20 {log}_{10} \{ {S}_{L} ( k ) / {N}_{L} ( k ) \} , \\ 0 ,\end{matrix} \begin{matrix}{S}_{L} ( k ) > {N}_{L} ( k ) \\ {S}_{L} ( k ) \leq {N}_{L} ( k )\end{matrix} & 0 \leq k < {K}_{L} ,\end{matrix} \qquad ( 2 )$$

Using the low-frequency noise suppression amount 107, the low-frequency noise suppressor unit 6 performs the noise suppression processing on the low-frequency amplitude spectrum 102 fed from the time/frequency converter unit 1, and supplies the result obtained to the first frequency/time converter unit 9 as a noise suppressed low-frequency amplitude spectrum 109 and to the band combining unit 8.

Here, as the noise suppression method in the low-frequency noise suppressor unit 6, it is possible to use not only a well-known method such as a method based on the spectral subtraction disclosed in the Non-Patent Document 1 or the spectral amplitude suppression that provides each spectral component with the amount of attenuation based on the signal-to-noise ratio of each spectral component as disclosed in the Non-Patent Document 2, but also a method combining the spectral subtraction and spectral amplitude suppression (a method described in Japanese Patent No. 3454190, for example).

The first frequency/time converter unit 9, using the noise suppressed low-frequency amplitude spectrum 109 fed from the low-frequency noise suppressor unit 6 and the phase spectrum 101, restores the time domain signal by performing inverse FFT processing corresponding to the number of FFT points (512 points) executed by the time/frequency converter unit 1, makes a concatenation while performing the windowing operation for smooth connection with preceding and following frames, and outputs the signal obtained as a noise suppressed low-frequency output signal 113. Incidentally, in the foregoing inverse FFT processing, as for the high-frequency spectral component of 4 kHz-8 kHz, zero filling is made.

A band control signal 111 is a signal for controlling switching between the narrow-band encoding unit 12 and the wide-band encoding unit 13 and the operation of a sampling converter unit 11 and the band combining unit 8, which will be described later, respectively. For example, it is a control signal for automatically switching an encoding method or transmission band in accordance with conditions of a wireless/wire communication channel, or a control signal for manually switching an encoding method or frequency range in response to a user request (such as a change of encoding quality or compression ratio of voice data). In the present embodiment, since the band control signal 111 switches between the two systems of the narrow-band encoding by the narrow-band encoding unit 12 and the wide-band encoding by the wide-band encoding unit 13, it has a value representing a “narrow-band mode” (0 (zero), for example) when encoding the noise suppressed input signal by a narrow-band encoding method, that is, when operating the narrow-band encoding unit 12, but has a value representing a “wide-band mode” (1, for example) when operating the wide-band encoding unit 13.

Receiving the noise suppressed low-frequency output signal 113 and the band control signal 111, the sampling converter unit 11 carries out, when the band control signal 111 for switching the voice encoding unit connected to the noise suppressor 200 is in the “narrow-band mode”, down-sampling from the sampling frequency of 16 kHz of the input signal 1 to 8 kHz, for example, and supplies a narrow-band output signal 114 to the narrow-band encoding unit 12.

Receiving the narrow-band output signal 114 and the band control signal 111, the narrow-band encoding unit 12 carries out, when the band control signal 111 is in the “narrow-band mode”, compression/encoding of the narrow-band output signal 114 using a well-known encoding method like an AMR (Adaptive Multi-Rate) voice encoding system, for example. The narrow-band output signal 114 passing through the encoding is transmitted through a wireless/wire communication channel as encoded data, for example, or is stored in a memory such as an IC recorder, and is read out to be used as voice/acoustic signal data thereafter.

Next, the operation of the components in the high-frequency processing unit 202 will be described.

According to the following expression (3), the high-frequency suppression amount control unit 5 calculates a signal-to-noise ratio snr_{H} (k) for each spectral component from the high-frequency amplitude spectrum 103 and the high-frequency noise spectrum 106 the noise spectrum estimation unit 3 outputs, which will be described later. Here, S_{H} (k) is a kth spectrum of the high-frequency amplitude spectrum 103, N_{H} (k) is a kth spectrum of the high-frequency noise spectrum 106, k is a spectral number, and K_{L} and K_{R} are the number of the spectral numbers, each. For example, if the number of FFT points 512 points, and a band divide point is 4 kHz, then K_{L}=128 and K_{H}=256. Using the signal-to-noise ratio SNR_{H} (k) obtained for each spectral component, the high-frequency suppression amount control unit 5 calculates the high-frequency noise suppression amount 108. As a concrete calculation method, it can use as in the case of the low-frequency processing unit 201, the well-known method such as a spectral subtraction method disclosed in the Non-Patent Document 1, and a Wiener Filter method disclosed in the Non-Patent Document 2.

$${snr}_{H} ( k ) = \{ \begin{matrix}\begin{matrix}20 {log}_{10} \{ {S}_{H} ( k ) / {N}_{H} ( k ) \} , \\ 0 ,\end{matrix} \begin{matrix}{S}_{H} ( k ) > {N}_{H} ( k ) \\ {S}_{H} ( k ) \leq {N}_{H} ( k )\end{matrix} & {K}_{L} \leq k < {K}_{H} ,\end{matrix} \qquad ( 3 )$$

Using the high-frequency noise suppression amount 108, the high-frequency noise suppressor unit 7 performs the noise suppression processing on the high-frequency amplitude spectrum 103 fed from the time/frequency converter unit 1, and supplies the result obtained to the band combining unit 8 as a noise suppressed high-frequency amplitude spectrum 110.

Here, as a noise suppression method in the high-frequency noise suppressor unit 7, as in the case of the low-frequency processing unit 201, it is possible to use not only a well-known method such as a method based on the spectral subtraction disclosed in the Non-Patent Document 1 or the spectral amplitude suppression that provides each spectral component with the amount of attenuation based on the signal-to-noise ratio for each spectral component as disclosed in the Non-Patent Document 2, but also a method combining the spectral subtraction and the spectral amplitude suppression.

The band combining unit 8 receives the noise suppressed low-frequency amplitude spectrum 109 the low-frequency noise suppressor unit 6 outputs, the high-frequency amplitude spectrum 110 the high-frequency noise suppressor unit 7 outputs, and the band control signal 111 for switching between the narrow-band and wide-band encoding methods, carries out, when the band control signal 111 is in the “wide-band mode”, band combining processing of connecting the high-frequency range and low-frequency range of the amplitude spectrum to form an all-band amplitude spectrum, and outputs a noise suppressed all-band amplitude spectrum 112.

Receiving the noise suppressed all-band amplitude spectrum 112 the band combining unit 8 outputs and the phase spectrum 101, the second frequency/time converter unit 10 restores the time domain signal by performing inverse FFT processing corresponding to the number of FFT points executed by the time/frequency converter unit 1, makes a concatenation while performing the windowing operation (superposition operation) for smooth connection with preceding and following frames, and supplies the signal obtained to the wide-band encoding unit 13 as a noise suppressed wide-band output signal 115.

Receiving the wide-band output signal 115 and the band control signal 111, the wide-band encoding unit 13 carries out, when the band control signal 111 is in the “wide-band mode”, compression/encoding of the wide-band output signal 115 using a well-known encoding method like an AMR-WB (Adaptive Multi-Rate Wide Band) voice encoding system, for example. As in the case of the narrow-band encoding unit 12, the wide-band output signal 115 passing through the encoding is transmitted as encoded data through a wireless/wire communication channel, for example, or is stored in a memory such as an IC recorder and is read out to be used as voice/acoustic signal data thereafter.

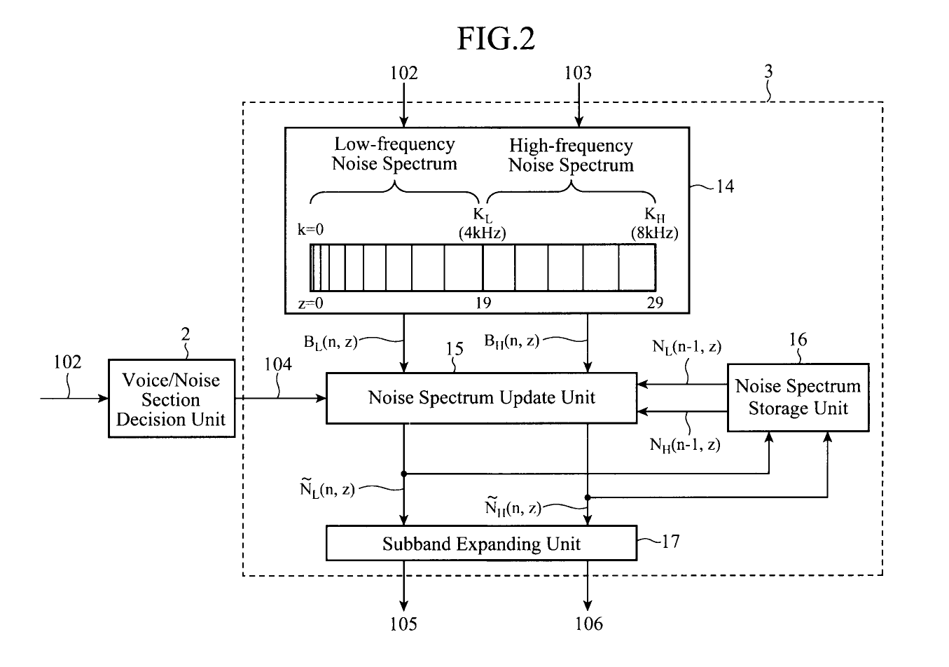

Next, the voice/noise section decision unit 2 in the low-frequency processing unit 201 and the noise spectrum estimation unit 3 which is a common component to the low-frequency processing unit 201 and high-frequency processing unit 202 will be described. The noise spectrum estimation unit 3, which constitutes a noise component estimation unit, comprises as shown in FIG. 2 a subband compression unit 14, a noise spectrum update unit 15, a noise spectrum storage unit 16, and a subband expanding unit 17.

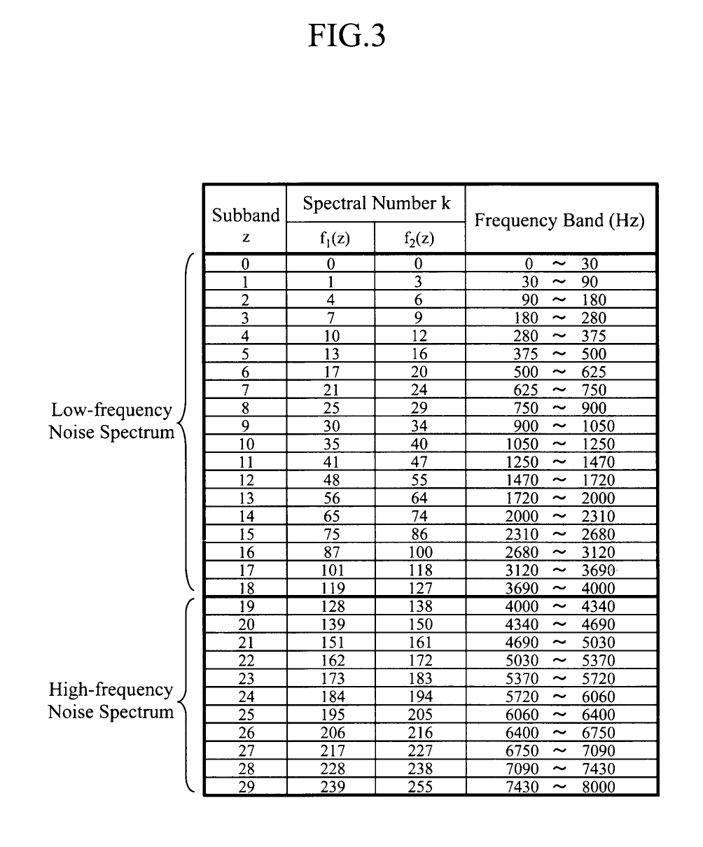

Referring to FIG. 2 and FIG. 3, detailed operation of the voice/noise section decision unit 2 and noise spectrum estimation unit 3 will be described.

First, using the low-frequency amplitude spectrum 102 output from the time/frequency converter unit 1 and the low-frequency noise spectrum 105 estimated from past frames, the voice/noise section decision unit 2 calculates a voice-like signal VAD indicating the degree of whether the input signal 100 of the current frame is voice or noise. For example, it takes a large evaluation value when a probability of voice is high and a small evaluation value when the probability of voice is low.

As a calculation method of the voice-like signal VAD, it is possible to use, singly or in combination, the low-frequency SN ratio of the current frame that can be obtained from a power ratio between the addition result of the low-frequency amplitude spectrum 102 of the input signal 100 and the addition result of the low-frequency noise spectrum 105 the noise spectrum estimation unit 3 which will be described later outputs, or the low-frequency power obtained from the low-frequency amplitude spectrum 102, or the variance of snr_{L} (k) obtainable from the SN ratio snr_{L} (k) of each spectral component given by the foregoing expression (2). Here, for simplification of explanation, the case of using the low-frequency SN ratio of the current frame singly will be described. The low-frequency SN ratio of the current frame SNR_{F L} can be given by the following expression (4)

$${SNR}_{FL} = max \{ 20 {log}_{10} ( {\sum }_{k = 0}^{{K}_{L} - 1} {S}_{L} ( k ) ) - 20 {log}_{10} ( {\sum }_{k = 0}^{{K}_{L} - 1} {N}_{L} ( k ) ) , 0 \} \qquad ( 4 )$$

Here, S_{L} (k) is a kth component of the low-frequency amplitude spectrum 102, N_{L} (k) is a kth component of the low-frequency noise spectrum 105, and K_{L} is the number of the spectral numbers in the low-frequency range. In addition, max{x, y} is a function that outputs a larger one of the elements x and y. The low-frequency SN ratio of the current frame SNR_{F L} takes a positive value not less than zero.

The voice-like signal VAD can be calculated from the low-frequency SN ratio SNR_{F L} obtained by expression (4) using the following expression (5), for example.

$$VAD = \{ \begin{matrix}1.0 , & {SNR}_{FL} > {TH}_{SNR} ( voice ) \\ 0.7 , & {TH}_{SNR} ( voicelike ) < {SNR}_{FL} \leq {TH}_{SNR} ( voice ) \\ 0.5 , & {TH}_{SNR} ( noiselike ) < {SNR}_{FL} \leq {TH}_{SNR} ( voicelike ) \\ 0.2 , & {TH}_{SNR} ( noise ) < {SNR}_{FL} \leq {TH}_{SNR} ( noiselike ) \\ 0.0 , & {SNR}_{FL} \leq {TH}_{SNR} ( noise )\end{matrix} \qquad ( 5 )$$

Here, TH_{S N R} (•) are each a threshold for decision, which is a prescribed constant. They can be adjusted in advance in such a manner that the voice section and noise section can be decided appropriately in accordance with the type and power of noise. The voice-like signal VAD calculated by the processing described above is supplied to the noise spectrum update unit 15 as a voice/noise section decision resultant signal 104.

Incidentally, although the voice-like signal VAD is expressed as discrete values in the range 0-1 in accordance with the prescribed decision thresholds in expression (5), it can also be handled as continuous values in the range 0-1 by normalizing SNR_{F L} by the maximum value (SNRmax_{F L}=50 dB, for example) as shown in expression (6), for example.

$$VAD = \{ \begin{matrix}1.0 , \\ {SNR}_{FL} / SNR {max}_{FL} ,\end{matrix} \begin{matrix}{SNR}_{FL} > SNR {max}_{FL} \\ {SNR}_{FL} \leq SNR {max}_{FL}\end{matrix} \qquad ( 6 )$$

To reduce the amount of processing and memory volume for storing the noise spectrum, according to expression (7) and the spectral table shown in FIG. 3, the subband compression unit 14 compresses the components with spectral numbers k of the low-frequency amplitude spectrum 102 and high-frequency amplitude spectrum 103 from 0 to 255 to average spectrum B_{L} (z) or B_{H} (z) for each subband z by collecting and averaging the components for each subband z consisting of 30-channels, for example, and supplies them to the noise spectrum update unit 15. Here, f_{L} (z) and f_{H} (z) are end points of the spectral components (band) corresponding to the subband z shown in FIG. 3.

$$\begin{matrix}{B}_{L} ( z ) = {\sum }_{k = {f}_{1} ( z )}^{{f}_{2} ( z )} \frac{{S}_{L} ( k )}{( {f}_{2} ( z ) - {f}_{1} ( z ) + 1 )} , & 0 \leq z \leq 18 \\ {B}_{H} ( z ) = {\sum }_{k = {f}_{1} ( z )}^{{f}_{2} ( z )} \frac{{S}_{H} ( k )}{( {f}_{2} ( z ) - {f}_{1} ( z ) + 1 )} , & 19 \leq z \leq 29\end{matrix} \qquad ( 7 )$$

FIG. 3 shows an example for the purpose of carrying out noise spectrum estimation superior in tracking ability in the frequency direction of the noise component in the high-frequency range while performing noise spectrum estimation in good characteristics in terms of auditory perception in the low-frequency range, which makes, using a small amount of memory, the band division according to a bark scale in 0-4 kHz and the equispaced band division at a critical bandwidth based on the bark scale near 4 kHz in 4 kHz-8 kHz, followed by averaging. However, to improve the accuracy of a particular frequency range (all band or high-frequency range), for example, it is also possible to perform more fine processing by using the amplitude spectra themselves instead of averaging the spectra.

Referring to the voice/noise section decision resultant signal 104 which is the output of the voice/noise section decision unit 2, the noise spectrum update unit 15 updates, when the mode of the input signal 100 in the current frame has high probability of noise, the estimated noise spectrum obtained from the past frames, which is stored in the noise spectrum storage unit 16, by using the low-frequency amplitude spectrum 102 and high-frequency amplitude spectrum 103, which are an input signal component of the current frame.

For example, according to the following expression (8), the noise spectrum update unit 15 carries out update by reflecting the amplitude spectrum of the input signal in the noise spectrum when the voice-like signal VAD, which is the voice/noise section decision resultant signal 104, is not greater than 0.2. The noise spectrum storage unit 16 consists of an electrical or magnetic random access memory typified by a semiconductor memory or hard disk, for example.

$$\{ \begin{matrix}\begin{matrix}{\tilde{N}}_{L} ( n , z ) = ( 1 - {α}_{L} ( z ) ) \cdot {N}_{L} ( n - 1 , z ) + \\ {α}_{L} ( z ) \cdot {B}_{L} ( n , z ) , \\ {\tilde{N}}_{L} ( n , z ) = {N}_{L} ( n - 1 , z ) ,\end{matrix} \begin{matrix}VAD \leq 0.2 \\ \\ VAD > 0.2 ;\end{matrix} & 0 \leq z \leq 18\end{matrix} \\ \{ \begin{matrix}\begin{matrix}{\tilde{N}}_{H} ( n , z ) = ( 1 - {α}_{H} ( z ) ) \cdot {N}_{H} ( n - 1 , z ) + \\ {α}_{H} ( z ) \cdot {B}_{H} ( n , z ) , \\ {\tilde{N}}_{H} ( n , z ) = {N}_{L} ( n - 1 , z ) ,\end{matrix} \begin{matrix}VAD \leq 0.2 \\ \\ VAD > 0.2 ;\end{matrix} & 19 \leq z \leq 29\end{matrix} \qquad ( 8 )$$

Here, α_{L} (z) and α_{H} (z) are a prescribed update speed coefficient taking a value of 0-1, which is preferably set at a value comparatively close to zero. In addition, there are some cases where it is better to increase the coefficient value to some extent or where it is possible to adjust it in accordance with the type of noise.

The subband expanding unit 17 expands the subband z to spectrum k components by performing inverse conversion of expression (7) on the foregoing updated noise spectra, supplies the low-frequency noise spectrum 105 to the low-frequency suppression amount control unit 4 and voice/noise section decision unit 2 described before, and supplies the high-frequency noise spectrum 106 to the high-frequency suppression amount control unit 5. Here, the low-frequency noise spectrum 105 supplied to the voice/noise section decision unit 2 is used for making the voice/noise section decision as to the next frame ((n+1)th frame).

Incidentally, as for the update method of the noise spectrum, to further improve the estimation accuracy or tracking ability to estimation, various modifications and improvements are possible: applying a plurality of update speed coefficients in accordance with the values of the voice/noise section decision resultant signal 104; applying such an update speed coefficient that will quicken the update speed when fluctuations in the input signal power or noise power observed between the frames are large; or replacing (resetting) the noise spectrum by the input signal spectrum of a frame with the minimum power in a fixed time period or of a frame in which the voice/noise section decision resultant signal 104 takes a minimum value. In addition, the update of the noise spectrum can be omitted when the value of the voice/noise section decision resultant signal 104 is large enough, that is, when the probability of voice of the input signal 100 in the current frame is high. Incidentally, as for the power of the input signal 100 and the power of noise, they can be calculated from the low-frequency amplitude spectrum 102 and low-frequency noise spectrum 105, for example.

According to the present embodiment 1, it is configured in such a manner as to make the voice/noise section decision using only the low-frequency component of the input signal, and to estimate the low-frequency noise spectrum and high-frequency noise spectrum according to the decision result. Accordingly, it can obviate the necessity of making the voice/noise section decision of the high-frequency processing unit, which is necessary in the conventional method, thereby being able to reduce the amount of processing and memory volume.

In addition, since the low-frequency processing and high-frequency processing can share the voice/noise section decision and noise spectrum estimation, which are important components in the noise suppressor, it can obviate the necessity for adjusting the control parameters independently in the low-frequency range and high-frequency range, thereby offering an advantage of being able to facilitate the control and adjustment.

Furthermore, since it makes the voice/noise section decision only from the low-frequency components, it can maintain the voice/noise section decision accuracy of the low-frequency input signal even for the voice signal into which noise with its power concentrated in the high-frequency range is mixed such as wind noise of a traveling car or fan noise of an air conditioner, thereby being able to estimate the noise spectrum correctly and as a result to achieve stable noise suppression.

Furthermore, since the present embodiment 1 alters from band to band the degree of subdivisions of internal components of the estimated noise components belonging to each band, it can make the noise spectrum estimation suitable for each band with a small amount of memory.

Furthermore, since the subband structure of the noise spectrum of the present embodiment 1 has a bark spectral band structure in the low-frequency range and an equispaced band structure in the high-frequency range, it enables quality noise spectrum estimation in terms of the auditory perception with a small amount of memory in the low-frequency range, and the noise spectrum estimation superior in tracking ability to the noise components in the high-frequency range.

Furthermore, the configuration of the present embodiment can implement a noise suppressor with a band scalable structure, which is compatible with the voice acoustic encoding system for a plurality of different bands, with a small amount of memory and a small amount of processing.

Although the present embodiment assumes to simplify explanations that the number of band division is two, the low-frequency range and high-frequency range, it can have three or more subdivisions, and the bandwidth after the division may be different such as 0-4 kHz/4-7 kHz/7-8 kHz, thereby being able to cope with various voice acoustic encoding systems. In this case, it can make the voice/noise section decision in the 0-4 kHz band, apply the voice/noise section decision result to the 0-4 kHz/4-7 kHz/7-8 kHz bands, respectively, and make the noise spectrum estimation of each band.

Furthermore, when the band control signal indicates the “narrow-band mode”, it can further reduce the amount of processing by suspending the operation of the high-frequency suppression amount control unit 5 and high-frequency noise suppressor unit 7 in the high-frequency processing unit 202, and by stopping supplying the band combining unit 8 with the noise suppressed low-frequency amplitude spectrum 109, which is the output result of the low-frequency noise suppressor unit 6.

As the number of frequency points required for the inverse FFT processing in the first frequency/time converter unit 9, although the present embodiment employs 512 which is the number of points equal to that of the time/frequency converter unit 1, it can also perform the inverse FFT processing using 256 points, for example, which is the number of points corresponding to the low-frequency amplitude spectrum 102, thereby being able to obviate the necessity of the sampling converter unit 11 and to further reduce the amount of processing.

### Embodiment 2

As a variation of the embodiment 1, a configuration is also possible which makes only the voice/noise section decision using an all-band amplitude spectrum, and has the same configuration as the embodiment 1 as to the other processing units, which will be described as an embodiment 2.

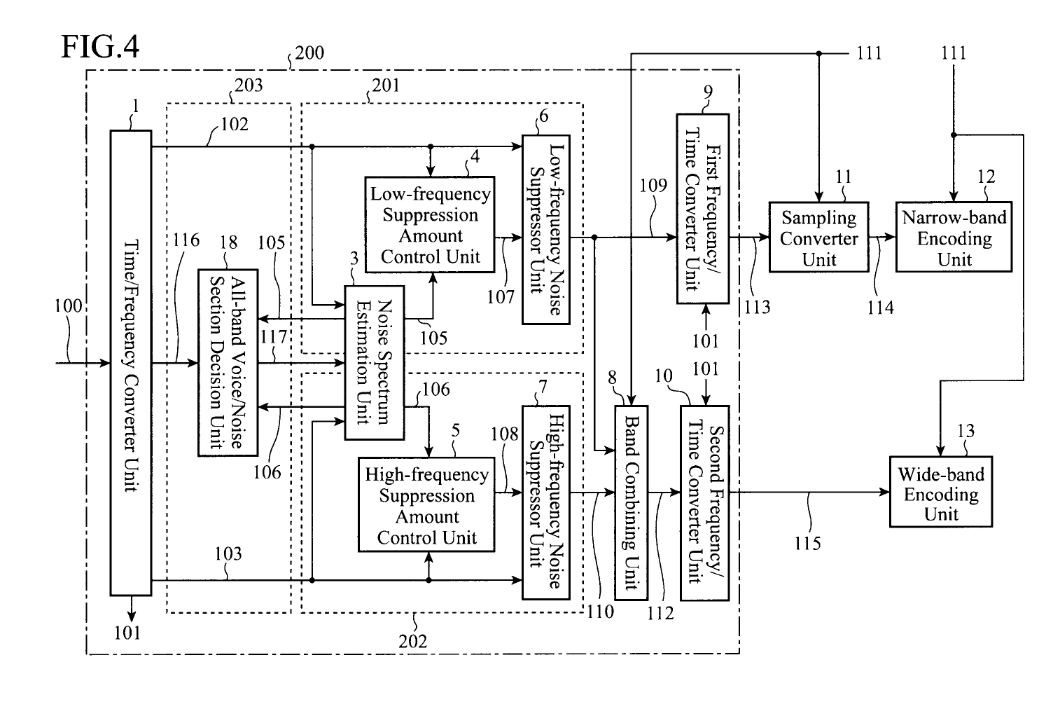

FIG. 4 is a block diagram showing a whole configuration of the noise suppressor of the embodiment 2. As a component different from FIG. 1, it has an all-band processing unit 203 including an all-band voice/noise section decision unit 18. As for the other components, since they are the same as those of FIG. 1 except that the voice/noise section decision unit 2 is removed from the low-frequency processing unit 201, description of their counterparts will be omitted by denoting them by the same reference numerals. Incidentally, the all-band processing unit 203 constitutes an analysis unit, and the low-frequency processing unit 201 and high-frequency processing unit 202 constitute a plurality of noise suppression units. In addition, the band combining unit 8 to the sampling converter unit 11 and the band control signal 111 constitute a switching unit.

The time/frequency converter unit 1 converts the input signal 100, which has undergone sampling and frame division at a prescribed sampling frequency and prescribed frame length (16 kHz and 20 ms, respectively, for example), to an amplitude spectrum and phase spectrum using the 512-point FFT, for example, followed by outputting the low-frequency amplitude spectrum 102 of the 0-4 kHz band component, the high-frequency amplitude spectrum 103 of the 4 kHz-8 kHz band component, an all-band amplitude spectrum 116 of 0-8 kHz, and the phase spectrum 101.

The all-band voice/noise section decision unit 18 which is the component of the all-band processing unit 203 calculates, as a degree of whether the input signal 100 of the current frame is voice or noise, the all-band voice-like signal VAD_{W I D E} that takes a large evaluation value when the probability of voice is high and a small evaluation value when the probability of voice is low, for example, by using the all-band amplitude spectrum 116 the time/frequency converter unit 1 outputs, the low-frequency noise spectrum 105 estimated from past frames and the high-frequency noise spectrum 106 also estimated from the past frames.

As a calculation method of the all-band voice-like signal VAD_{W I D E} it is possible to use the all-band SN ratio of the current frame that can be obtained from a power ratio between the addition result of the all-band amplitude spectrum 116 of the input signal 100 and the addition result of the low-frequency noise spectrum 105 and the high-frequency noise spectrum 106 the noise spectrum estimation unit 3 outputs, or to use the frame power obtained from the all-band amplitude spectrum 116, or to use the variance of an SN ratio of each spectral component calculated in the same method as the foregoing expression (2) singly or by combining them. Here, for convenience of explanation as in the embodiment 1, the case of using the all-band SN ratio of the current frame singly will be described. The all-band SN ratio of the current frame SNR_{W I D E}_{_{—}}_{F L} can be given by the following expression (9).

$${SNR}_{WIDE \_ FL} = max \{ 20 {log}_{10} ( {\sum }_{k = 0}^{{K}_{H} - 1} S ( k ) ) - 20 {log}_{10} ( {\sum }_{k = 0}^{{K}_{L} - 1} {N}_{L} ( k ) + {\sum }_{k = {K}_{L}}^{{K}_{H} - 1} {N}_{H} ( k ) ) , 0 \} \qquad ( 9 )$$

Here, S(K) is a kth component of the all-band amplitude spectrum 116, N_{L} (k) and N_{H} (k) are a kth component of the low-frequency noise spectrum 105 and high-frequency noise spectrum 106, respectively, and K_{L} and K_{H} are the number of the spectral numbers in the low-frequency range and high-frequency range. In addition, max{x, y} is a function that outputs a larger one of the elements x and y. Thus, the all-band SN ratio of the current frame SNR_{W I D E}_{_{—}}_{F L} takes a positive value not less than zero.

The all-band voice-like signal VAD_{W I D E} can be calculated from the all-band SN ratio SNR_{W I D E}_{_{—}}_{F L} obtained by expression (9) using the following expression (10) in the same manner as in the embodiment 1, for example.

$${VAD}_{WIDE} = \{ \begin{matrix}1.0 , & {SNR}_{WIDE \_ FL} > {TH}_{SNR} ( voice ) \\ 0.7 , & {TH}_{SNR} ( voicelike ) < {SNR}_{WIDE \_ FL} \leq {TH}_{SNR} ( voice ) \\ 0.5 , & {TH}_{SNR} ( noiselike ) < {SNR}_{WIDE \_ FL} \leq {TH}_{SNR} ( voicelike ) \\ 0.2 , & {TH}_{SNR} ( noise ) < {SNR}_{WIDE \_ FL} \leq {TH}_{SNR} ( noiselike ) \\ 0.0 , & {SNR}_{WIDE \_ FL} \leq {TH}_{SNR} ( noise )\end{matrix} \qquad ( 10 )$$

Here, TH_{S N R} (•) are thresholds for decision, which are a prescribed constant each. They can be adjusted in advance in such a manner that the voice section and noise section can be decided appropriately in accordance with the type and power of noise. The all-band voice-like signal VAD_{W I D E} calculated by the processing described above is supplied to the noise spectrum update unit 15 in the noise spectrum estimation unit 3 as an all-band voice/noise section decision resultant signal 117.

Incidentally, although the all-band voice-like signal VAD_{W I D E} is expressed as a discrete value in the range 0-1 in accordance with the prescribed decision thresholds in expression (10), it can also be handled as a continuous value in the range 0-1 by normalizing SNR_{W I D E}_{_{—}}_{F L} with respect to the maximum value (SNRmax_{W I D E}_{_{—}}_{F L}=60 dB, for example) as shown in expression (11), for example.

$${VAD}_{WIDE} = \{ \begin{matrix}1.0 , \\ {SNR}_{WIDE \_ FL} / SNR {max}_{WIDE \_ FL} ,\end{matrix} \begin{matrix}{SNR}_{WIDE \_ FL} > SNR {max}_{WIDE \_ FL} \\ {SNR}_{WIDE \_ FL} \leq SNR {max}_{WIDE \_ FL}\end{matrix} \qquad ( 11 )$$

When the mode of the input signal 100 in the current frame has a high probability of noise, the noise spectrum estimation unit 3 updates the noise spectrum and outputs the low-frequency noise spectrum 105 and high-frequency noise spectrum 106 using the all-band voice/noise section decision resultant signal 117 the all-band voice/noise section decision unit 18 outputs and using the low-frequency amplitude spectrum 102 and high-frequency amplitude spectrum 103 the time/frequency converter unit 1 outputs. Here, as an update method of the noise spectrum and a storage method of the noise spectrum, the same methods as those of the embodiment 1 can be employed, for example.

Using the low-frequency amplitude spectrum 102 the time/frequency converter unit 1 outputs and the low-frequency noise spectrum 105 the noise spectrum estimation unit 3 outputs, the low-frequency processing unit 201 calculates the low-frequency noise suppression amount 107 with the low-frequency suppression amount control unit 4. Using the low-frequency noise suppression amount 107 calculated, the low-frequency noise suppressor unit 6 carries out the noise suppression of the low-frequency amplitude spectrum 102, and outputs the noise suppressed low-frequency amplitude spectrum 109. Here, as a method of the processing by the low-frequency suppression amount control unit 4 and low-frequency noise suppressor unit 6, the same method as that of the embodiment 1 can be employed, for example.

Using the high-frequency amplitude spectrum 103 the time/frequency converter unit 1 outputs and the high-frequency noise spectrum 106 the noise spectrum estimation unit 3 outputs, the high-frequency processing unit 202 calculates the high-frequency noise suppression amount 108 with the high-frequency suppression amount control unit 5. Using the high-frequency noise suppression amount 108 calculated, the low-frequency noise suppressor unit 7 carries out noise suppression of the high-frequency amplitude spectrum 103, and outputs a noise suppressed high-frequency amplitude spectrum 110. Here, as a method of the processing by the high-frequency suppression amount control unit 5 and high-frequency noise suppressor unit 7, the same method as that of the embodiment 1 can be employed, for example.

Using the noise suppressed low-frequency amplitude spectrum 109 supplied from the low-frequency noise suppressor unit 6 and the phase spectrum 101, the first frequency/time converter unit 9 restores the time domain signal by performing the inverse FFT corresponding to the number of FFT points (512 points) which the time/frequency converter unit 1 carries out, makes concatenation while performing a windowing operation for smooth connection with the preceding and following frames, and outputs the signal obtained as the noise suppressed low-frequency output signal 113. Incidentally, as for the high-frequency spectral component of 4 kHz-8 kHz in the foregoing inverse FFT processing, zero filling is made.

The sampling converter unit 11 receives the noise suppressed low-frequency output signal 113 and the band control signal 111, performs, when the value of the band control signal 111 for switching the voice encoding unit connected to the noise suppressor 200 is in the “narrow-band mode”, down-sampling of the input signal 1 from its sampling frequency of 16 kHz to 8 kHz, and supplies the narrow-band output signal 114 to the narrow-band encoding unit 12.

The narrow-band encoding unit 12 receives the narrow-band output signal 114 and the band control signal 111, and performs, when the band control signal 111 is in the “narrow-band mode”, the compression/encoding of the narrow-band output signal 114 using the well-known encoding method such as an AMR voice encoding system in the same manner as in the embodiment 1.

Receiving the noise suppressed low-frequency amplitude spectrum 109 the low-frequency noise suppressor unit 6 outputs, the high-frequency amplitude spectrum 110 the high-frequency noise suppressor unit 7 outputs, and the band control signal 111 for switching between the narrow-band/wide-band encoding method, the band combining unit 8 carries out, when the band control signal 111 is in the “wide-band mode”, the band combining processing for generating an all-band amplitude spectrum by uniting the high-frequency range and the low-frequency range of the amplitude spectrum, and supplies the noise suppressed all-band amplitude spectrum 112.

Receiving the noise suppressed all-band amplitude spectrum 112 the band combining unit 8 outputs and the phase spectrum 101, the second frequency/time converter unit 10 restores the time domain signal by performing the inverse FFT processing corresponding to the number of FFT points executed by the time/frequency converter unit 1, makes concatenation while performing a windowing operation (superposition processing) for smooth connection with the preceding and following frames, and supplies the signal obtained to the wide-band encoding unit 13 as the noise suppressed wide-band output signal 115.

The wide-band encoding unit 13 receives the wide-band output signal 115 and the band control signal 111, and performs, when the band control signal 111 is in the “wide-band mode”, the compression/encoding of the wide-band output signal 115 using the well-known encoding method such as an AMR-WB voice encoding system in the same manner as in the embodiment 1.

According to the present embodiment 2, since it is configured in such a manner as to make a voice/noise section decision using the all-band signal of the input signal, and to estimate the low-frequency noise spectrum and the high-frequency noise spectrum in accordance with the result of the estimation, it can eliminate the voice/noise section decision of the high-frequency processing unit which is required in the conventional method, thereby offering an advantage of being able to reduce the amount of processing and memory volume.

Furthermore, since the low-frequency processing and the high-frequency processing can share the voice/noise section decision and noise spectrum estimation, which are important components in the noise suppressor, the present embodiment can obviate the need for adjusting the control parameters in the low-frequency range and high-frequency range, thereby being able to simplify the control and adjustment of them.

Besides the two foregoing advantages, since the present embodiment makes the voice/noise section decision by using the all-band signal including not only the low-frequency component but also the high-frequency component of the input signal, it can increase the amount of information for analyzing the voice likeness of the input signal, and increase the voice/noise section decision accuracy, thereby being able to further improve the quality of the noise suppressor.

In addition, since the subband structure of the noise spectrum has the bark spectral band in the low-frequency range and the equispaced band in the high-frequency range, the present embodiment can make quality noise spectrum estimation in terms of the auditory perception in the low-frequency range and the noise spectrum estimation superior in the tracking ability to the noise component in the high-frequency range with a small amount of memory.

Furthermore, the configuration of the present embodiment makes it possible to construct a noise suppressor with a band scalable structure compatible with the voice acoustic encoding system with a plurality of different bands with a small amount of memory and processing.

Although the present embodiment assumes to simplify explanations that the number of band division is two, the low-frequency range and high-frequency range, it can have three or more subdivisions, and the bandwidth after the division may be different such as 0-4 kHz/4-7 kHz/7-8 kHz, thereby being able to cope with various voice acoustic encoding systems.

Furthermore, when the band control signal indicates the “narrow-band mode”, it can further reduce the amount of processing by suspending the operation of the high-frequency suppression amount control unit 5 and high-frequency noise suppressor unit 7 in the high-frequency processing unit 202, and by stopping supplying the band combining unit 8 with the noise suppressed low-frequency amplitude spectrum 109 which is the output result of the low-frequency noise suppressor unit 6.

As the number of frequency points required for the inverse FFT processing in the first frequency/time converter unit 9, although the present embodiment employs 512 which is the number of points equal to that of the time/frequency converter unit 1, it can also perform the inverse FFT processing using 256 points, for example, which is the number of points corresponding to the low-frequency amplitude spectrum 102, thereby being able to obviate the necessity of the sampling converter unit 11 and to further reduce the amount of processing.

### Embodiment 3

As a variation of the embodiment 2, a configuration is also possible which divides the all-band amplitude spectrum fed to the all-band voice/noise section decision unit 18 in the all-band processing unit 203 into a plurality of bands, employs a combined result of the voice/noise section decisions of the individual bands as the all-band voice/noise section decision result, and has the same configuration as the embodiment 2 as for the processing thereafter. It will be described below as an embodiment 3.

As for the band division method or the number of band divisions of the all-band amplitude spectrum 116 in the all-band voice/noise section decision unit 18, it is unnecessary to stick to the bands of the low-frequency processing unit 201 and high-frequency processing unit 202. For example, three divisions of 0-2 kHz/2-4 kHz/4-8 kHz is possible. Furthermore, a configuration is also possible which has bands overlapping such as 0-4 kHz/2-8 kHz because of superimposing an analysis band on an important band for detecting voice, and which lacks a band such as 1 kHz-4 kHz/6-8 kHz to make analysis by avoiding a band into which peak noise is mixed continuously. By superimposing the important band for voice detection or by making analysis while avoiding peak noise, the present embodiment can further improve the voice/noise section decision accuracy.

As the voice/noise section decision method of the individual bands passing through the band division, a method similar to that of the embodiment 2 can be employed. For example, a method is possible which modifies and applies expressions (9) and (10) for the individual bands, and adjusts the parameters such as the number of spectrums and threshold values appropriately in accordance with the bands divided. As for the voice-like signals in the individual bands thus obtained, a weighted average as shown in the following expression (12) is calculated, for example, and the all-band voice-like signal VAD_{W I D E} which is the result thereof is output as the all-band voice/noise section decision resultant signal 117.

$${VAD}_{WIDE} = \frac{1}{M} {\sum }_{m = 0}^{M - 1} {w}_{VAD} ( m ) \cdot {VAD}_{SB} ( m ) \qquad ( 12 )$$

Here, M is the number of the band divisions and VAD_{S B} (m) is the voice-like signal in a band m after the band division. In addition, W_{V A D} (m) is a prescribed weighted coefficient in the band m, which is to be adjusted appropriately in accordance with the band division method and the type of noise in such a manner as to obtain a better voice/noise section decision result.

According to the present embodiment 3, it can further improve the voice/noise section decision accuracy by superimposing an important band for voice detection or by analyzing by avoiding the peak noise in the voice/noise section decision, and can further improve the quality of the noise suppressor in addition to the advantages described in the embodiment 2.

### Embodiment 4

As a variation of the embodiment 1, a configuration is also possible which carries out noise suppression after voice decoding processing, which will be described as an embodiment 4.

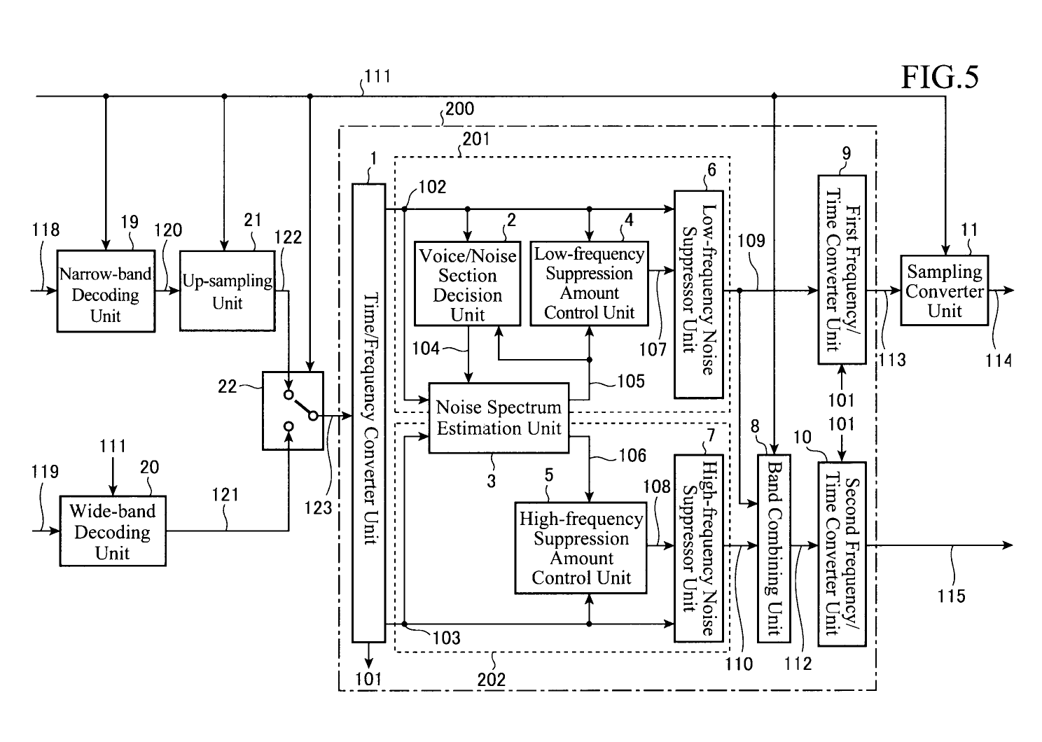

FIG. 5 is a block diagram showing a whole configuration of the noise suppressor of the embodiment 4. It differs from the configuration of FIG. 1 in that it has a narrow-band decoding unit 19, a wide-band decoding unit 20, an up-sampling unit 21, and a switching unit 22 on the input side of the noise suppressor 200. Furthermore, the narrow-band encoding unit 12 and wide-band encoding unit 13 in FIG. 1 are not connected. As for the remaining configuration, since it is the same as that of FIG. 1, the description thereof is omitted by assigning the same reference numerals to the corresponding components.

For example, via a wire/wireless communication channel or via a storage unit such as a memory, and according to the band control signal 111 for switching the decoding system, when the band control signal 111 is in the “narrow-band mode”, narrow-band encoded data 118 is supplied to the narrow-band decoding unit 19, and when the band control signal 111 is in the “wide-band mode”, wide-band encoded data 119 is supplied to the wide-band decoding unit 20. Incidentally, each of the encoded data is a result a separate voice encoding unit (such as an AMR voice encoding system or an AMR-WB voice encoding system) obtains by encoding a voice acoustic signal.

The narrow-band decoding unit 19 performs prescribed decoding processing corresponding to the foregoing voice encoding unit on the narrow-band encoded data 118, and supplies a narrow-band decoded signal 120 to the up-sampling unit 21 which will be described below.

The wide-band decoding unit 20 performs prescribed decoding processing corresponding to the foregoing voice encoding unit on the wide-band encoded data 119, and supplies a wide-band decoded signal 121 to the switching unit 22.

The up-sampling unit 21 receives the narrow-band decoded signal 120, carries out up-sampling processing to the same sampling frequency as that of the wide-band decoded signal 121, and outputs as an up-sampled narrow-band decoded signal 122.

The switching unit 22 receives the wide-band decoded signal 121, the up-sampled narrow-band decoded signal 122 and the band control signal 111, outputs, when the band control signal 111 is in the “narrow-band mode”, the up-sampled narrow-band decoded signal 122 as a decoded signal 123, and outputs, when the band control signal 111 is in the “wide-band mode”, the wide-band decoded signal 121 as a decoded signal 123.

The time/frequency converter unit 1 performs, in the same manner as in the embodiment 1, the frame division and windowing operation on the decoded signal 123 instead of the input signal 100, carries out an FFT of the signal passing through the windowing, supplies the low-frequency amplitude spectrum 102, which has spectral components for individual frequencies, to the voice/noise section decision unit 2, low-frequency suppression amount control unit 4, low-frequency noise suppressor unit 6 and noise spectrum estimation unit 3 in the low-frequency processing unit 201, and supplies the high-frequency amplitude spectrum 103 to the high-frequency suppression amount control unit 5, high-frequency noise suppressor unit 7 and noise spectrum estimation unit 3 in the high-frequency processing unit 202.

The noise spectrum estimation unit 3, using the voice/noise section decision resultant signal 104, low-frequency amplitude spectrum 102 and high-frequency amplitude spectrum 103, estimates the average noise spectrum in the decoded signal 123, and outputs it as the low-frequency noise spectrum 105 and high-frequency noise spectrum 106. Incidentally, as for the configuration and individual items of the processing in the noise spectrum estimation unit 3 and as for the processing of the voice/noise section decision unit 2, the same as those of the embodiment 1 can be employed.

Since the processing contents thereafter are the same as those of the embodiment 1, their description will be omitted.

According to the present embodiment 4, since the low-frequency processing and high-frequency processing can share the voice/noise section decision and noise spectrum estimation, which are important components in the noise suppressor, it can obviate the necessity for adjusting the control parameters independently in the low-frequency range and high-frequency range, thereby offering an advantage of being able to facilitate the control and adjustment.

Furthermore, the configuration of the present embodiment can implement a noise suppressor with a band scalable structure, which is compatible with the voice acoustic encoding system for a plurality of different bands, with a small amount of memory and a small amount of processing.

Incidentally, the same advantages as those described above can be achieved by replacing the internal configuration of the noise suppressor 200 of the present embodiment shown in FIG. 5 by the internal configuration of the noise suppressor 200 of the embodiment 2 shown in FIG. 4.

### Embodiment 5

Although the foregoing embodiments 1 to 4 calculate the spectral components by the fast Fourier transform, execute modification processing and restore the time domain signal by the inverse fast Fourier transform, a configuration is also possible which performs noise suppression processing on the individual outputs of a bank of bandpass filters instead of the fast Fourier transform, and obtains the output signal by adding signals of individual bands. Besides, a configuration is also possible which uses a conversion function such as a wavelet transform.

According to the present embodiment 5, it can offer the same advantages as those mentioned in the embodiments 1 to 4 without using a Fourier transform.

### INDUSTRIAL APPLICABILITY

As described above, the noise suppressor in accordance with the present invention relates to a configuration for suppressing noise or an unintended signal from the input signal into which noise is mixed, and is suitable for an application to a voice communication system, voice storage system, and voice recognition system used in various noise environments.

What is claimed is:

1. A noise suppressor that divides an input signal into a plurality of bands; that performs, in accordance with an analysis result of a prescribed band component of the plurality of bands divided, noise suppression of the prescribed band component; and that performs noise suppression of a band component other than the prescribed band component.

2. The noise suppressor according to claim 1, further comprising:
a noise component estimation unit for extracting an estimated noise component belonging to each band of the plurality of bands from the input signal, wherein
a degree of subdivision of internal components of the estimated noise component differs for each of the bands.

3. The noise suppressor according to claim 2, wherein
as the degree of subdivision of the internal components of the estimated noise component, the estimated noise component is subdivided unequally in a low-frequency range, and is subdivided equally in a high-frequency range.

4. A noise suppressor comprising:
an analysis unit for analyzing an all-band component of an input signal;
a plurality of noise suppression units for performing noise suppression of a plurality of band components obtained by dividing the input signal into bands; and
a switching unit for switching between the noise suppression unit of the all-band component and that of a partial band component, wherein
the noise suppressor performs noise suppression processing of the all-band component or of the partial band component in response to an analysis result of the analysis unit.
